(19) United States
(12) Patent Application Publication
(10) Pub. No.: US 2022/0214905 A1
(43) Pub. Date: Jul. 7, 2022

(54) SYSTEM AND METHOD OF OPTIMIZING VM DISK DATA TRANSFER TIME FOR COLD MIGRATION BY PRELOADING PAGE-CACHE

(71) Applicant: Flipkart Internet Private Limited, Bangalore (IN)

(72) Inventors: Kannan BALAKUMARAN, TamilNadu (IN); Krishna KUMAR, Bangalore (IN); Vasudeva Sathish KAMATH B, Karnataka (IN)

(21) Appl. No.: 17/570,692

(22) Filed: Jan. 7, 2022

(30) Foreign Application Priority Data
Jan. 7, 2021 (IN) 202141000783

(51) Int. Cl. G06F 9/455; G06F 9/4401; G06F 12/0882

(52) U.S. Cl. CPC G06F 9/45558; G06F 9/4408; G06F 2009/4557; G06F 2009/45583; G06F 12/0882

(57) ABSTRACT

A fast copy method and systems for virtual machine migration. Data from the source virtual machine's (VM1) root disk is read into source server's system memory, populating data of VM1's root disk into the host's server's page cache. Data from the destination VM's (VM2) root disk is read into destination server's system memory, thereby populating data of VM2's root disk into the host's page cache. A file descriptor used to read root disks of VM1 and VM2 on both source and destination servers are kept open even after reads are complete, so page cache entries are not evicted by the source and destination servers. This enables subsequent copies of VM1's root disk to the destination server to utilize the page cache on both source and destination servers, instead of reading and writing to both VM's root disks respectively, significantly reducing the time for root disk content transfer during cold migration.

### FIELD OF THE INVENTION

The present disclose relates to fast migration of data from a virtual machine to another. The present invention describe a problem with cold migration and a method to solve it.

### BACKGROUND

Virtualization in computer can provide multiple virtual machines (VMs) on a physical machine, with each VM looking like a full computer to “guest” software running inside the VM. This enables a user to concurrently run multiple copies of a guest operating system on one physical machine, with each guest having its own copy of “virtual hardware.” The virtual machines can be moved from one server to another, this can be undertaken to perform regular maintenance and update functions. The process by which a VM is moved from one physical server to another is called Migration. Migration can be broadly defined into two kinds a) Live migration: where the VM is migrated without downtime or disruption in service; b) Cold migration: where the VM is migrated with some downtime.

Many cloud providers implement cold migration for various reasons for example server hardware characteristics mismatch on the source and destination servers (e.g. CPU type, features, architecture family), VM kernel version may not support live migration, host hypervisor version may not support live migration, etc. Cold migration does not have these requirements and can work in every environment.

Cold migration requires that the VM is shut down on the source server, and started on the destination server, without loss of data. Typically, VM's in a data center are created with one or more Hard disks (HDD): a root disk, which is a small partition, contains an operating system, libraries, application binaries, and application configuration files. This is a small disk present physically on the host server, and virtualized to the locally running VM to use as it's root disk, zero, or more additional disks. Typically, these are large disk(s) that contain application data. These disks are usually network-attached, or any other mechanism that provides disaggregated storage.

During cold migration, existing application state, e.g., the state of system memory, TCP/IP network connections, state of running applications, etc. is not preserved. When migration is complete, it is expected that the new VM will come up with the earlier consistent state of the root disk, and applications can start and resume service without loss of data. If additional disks are present, they would be available to this VM on the destination server in the same way that it was accessed from the VM on the source server (e.g., over network, or by other means). Since data disks are network-attached and not local to the server, that data is not required to be copied from the source server to the destination server. Only the root disk present on the local system requires to be copied, so that the operating system, libraries, application binaries and configuration files, etc. are available on the destination server. This allows the application to start up after reading it's configuration settings from the root disk, and resume operation.

In simple steps, the usual process of implementing a cold migration includes, shut down the VM on the source server, Copying the root disk contents from the source server over the network to the destination server, and Start the VM on the destination server, using the saved root disk contents as its root disk.

Today, most data centers operate on fast network speeds, usually, 10g, 25g, etc. Upon calculating the time to transfer 10 GB of data between two servers over a 10g network link:

Network transfer rate=10 gbps

Data set size to be copied=10 GB=10*1000*1000*1000 bytes=10*1000*1000*1000*8 bits.

Time to transfer=(10*1000*1000*1000*8 bits)/(10*1000*1000*1000 bits/second)=8 seconds.

However, the root disk data on the source server is present on a hard disk drive (HDD), which has a very slow transfer rate—about 100 MB/s. Similarly, when the data arrives at the destination server over the network, that needs to be copied to an HDD on the destination server—another slow device. Using this framework, we calculate the time to copy the data from a HDD on the source server to a HDD on the destination server:
Time to read 10 GB on the source server=(10*1000*1000*1000)/(100*1000*1000)=100 seconds.
Time to transfer 10 GB over the network to the destination server=8 seconds.
Time to write 10G to the destination HDD=100 seconds
Total disk copy operation time=3 minutes 28 seconds
Note: This assumes:
   Network is fully utilized at 10 gbps, and,
   Disk is read at consistently 100 MB/s.

This large operation time significantly affects the ability to perform fast VM cold-migration operations, especially in a data center with thousands, or tens of thousands, of instances, where many VM's may need to be migrated due to reasons like—server load balancing, scheduled server maintenance, disaster recovery, etc.

Usually page caches are kept as long as a reference to them is maintained, e.g.: an application opens a file, reads some data, and keeps the file open. Most operating systems evict the page cache under a few circumstances:

1. Application closes the file (however, different operating system implementations can decide whether to keep the application data in page cache or not).

2. The filesystem containing the file is unmounted.

3. The system runs out of free memory.

Accessing (read/write) the page cache is significantly faster than accessing (read/write) of the HDD. As an example, the following shows the time to read 10 GB directly from disk vs the time it takes to do a second read, where the second operation takes advantage of the fact that the data read previously is present in the page cache (this is shown on a server running a Unix family of operating systems, using the ‘dd’ command—a disk copy utility):

1. First time read without any disk data in the page-cache:

#dd if=/dev/sdb of=/dev/null bs=1 M count=10000

10000+0 records in

10000+0 records out

10485760000 bytes (10 GB) copied, 104.967 s, 99.9 MB/s

2. Second time read, where most of the data that was read the first time, is present in the page-cache:

#dd if=/dev/sdb of=/dev/null bs=1 M count=10000

10000+0 records in

10000+0 records out

10485760000 bytes (10 GB) copied, 1.45017 s, 7.2 GB/s

The first operation took 105 seconds at a speed of 100 MB/s, while the latter took a mere 1.45 seconds at a speed of 7.2 GB/s, or 72 times faster.

Hence, a need exists for improving data transfer time during migration so as to improve VM cold migration time.

### SUMMARY OF THE INVENTION

According to one or more embodiments of the present invention disclosed is a method for speeding up migration of a source Virtual Machine (VM1) on a source host server to a destination host server where a destination virtual machine (VM2) will come live after migration completes, wherein the migration is controlled based on instructions issued by a controller or an orchestrator, comprising steps of reading the entire root disk of the source VM (VM1) into the host server's memory for populating the page-cache on the source server with the contents of the VM1's root disk, keeping the page cache entries alive in the source host server's memory by keeping a first file descriptor of the VM1's root disk open till the entire migration process completes, concurrently issuing instruction to the destination server to read the root disk contents of VM2 root disk into the host server's memory, thereby populating the page-cache on the destination server with contents of VM2's root disk, keeping the page cache entries alive in the destination host server's memory by keeping a second file descriptor to the VM2's root disk open till the entire migration process completes, wherein VM2's root disk does not have any content populated yet, and that it is just an empty disk whose empty contents is merely present in the destination host server's page-cache, issue a shutdown command for VM1 whereby the VM1 flushes it's memory and/or buffers to it's root disk and the VM 1 writes its modified data to the disk by either updating the host server's page cache entry, or invalidate those specific page-cache entries in the host server, performing data copy operation from the source VM's (VM1) root disk to the destination VM's (VM2) root disk; where most of the I/O operations take place directly from the page cache on the host server, and to the page cache on the destination server, due to the presence of the VM's root disk contents in the page-caches on both servers.

The embodiments further, comprises of initializing a new file descriptor or reusing an existing file descriptor for reading data from source root disk so as to copy over the network to the destination server, where the disk contents are present in the source server's page cache due to earlier read operation. Further, comprising of copying incoming data from the source server to the root disk on the destination server, utilizing a new file descriptor or reusing an existing file descriptor to VM2's root disk, so that the data being copied is instead written to the page-cache rather than the disk due to the presence of a file-descriptor which is already kept open to the root disk on the destination server. Wherein once the network transfer and copy operations are complete, start the VM2 on the destination server. The open file descriptors can be closed at this time.

In the present invention by taking advantage of the fact that most or all of the VM1's disk data is present in the source host server, which results in the data being read mostly from memory. Similarly, all writes to the destination VM2's root disk will get updated in the destination host servers page-cache entries, instead of synchronously writing to the physical disk”.

### BRIEF DESCRIPTION OF DRAWINGS

FIG. 1 illustrates an embodiment of the present invention for performing fast copy of data.

FIG. 2 illustrates an embodiment of the present invention for initializing one or more file descriptor.

FIG. 3 illustrates an process flow of an embodiment of the present invention.

### DETAILED DESCRIPTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like reference numerals refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the hardware and/or software components required for the unit to function. Further, each unit may comprise within itself one or more components which are implicitly understood. These components may be operatively coupled to each other and be configured to communicate with each other to perform the function of the said unit.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present disclosure describes a method, system to significantly speed up the cold migration process by preloading the VM's page-cache on a source server, and a similar operation on the destination server. Most modern operating systems implement quick access to storage using a page-cache mechanism. A page-cache is a transparent cache of data that originates on a storage device, such as a hard disk. Operating systems utilize unused portions of the main memory to keep a copy of the disk data.

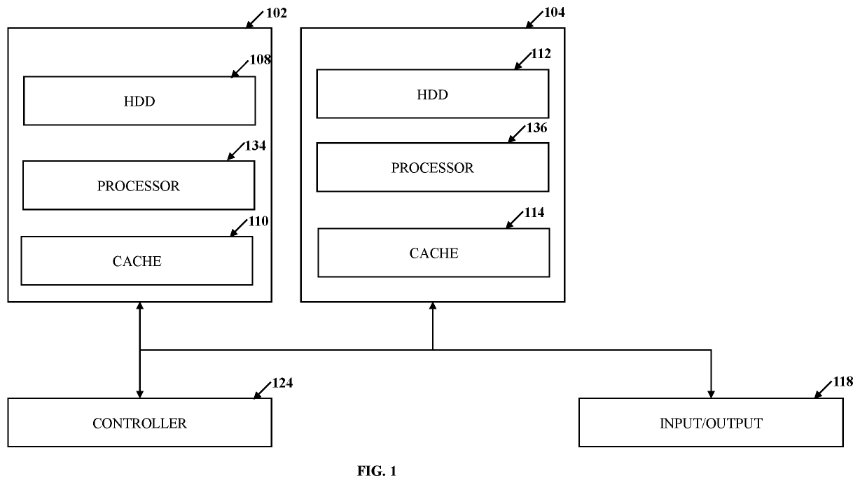

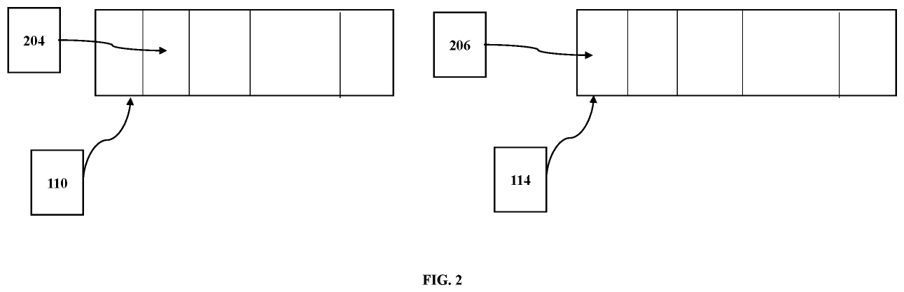

FIG. 1 illustrates a block diagram of a computing environment 100 in which data from VM1 is migrated from a page-cache 110 of a source server 102 to a destination server 104 and start as VM2. FIG. 2 illustrates a file descriptor initialization on source server 102 and destination server 104. The source and destination servers may represent desktop computer systems, laptop computer systems, smartphones, servers, network elements, or other types of computer systems. As shown, the source and destination servers may be coupled, or otherwise in communication with one another, by one or more intervening networks 132. In one aspect, the source and destination servers may be coupled over the Internet (e.g., the “cloud”). Alternatively, the source and destination servers may be coupled more directly by one or more local wired or wireless links.

The server 102 includes at least one processor 134, a Hard Disk Drive (HDD) memory 108, and a page-cache memory 110. The memory 108 and the cache 110 may represent different portions of system memory that may include one or more types of physical memory (e.g., dynamic random access memory (DRAM), flash memory, etc.). The memory 108 and page-cache memory 110 may have different levels of protection or security enforced in part by logic of the processor 134. The memory 108 may represent a portion of the system memory of the type commonly used to store applications, data, and the like. Similarly, server 104 and 106 include related regular memory 112 and page-cache memory 114. On the server 102, 104 the page-cache 110, 114 may be implemented using in-cache memory, unified page cache memory or the likes. A person skilled in the art can readily understand the different arrangement of page-cache memory.

Specifically, in FIG. 1 the page-cache memory 110 which is being used by Vm1 on server 102 and page-cache memory 114 serving VM2 on server 104 opens a file descriptor 204 as shown in FIG. 2 to block correlating page-cache block, on both source 102 and on the destination server 104 a file descriptor 206 refers a new memory address block that is used as the source or root disk for operation of Vm1 after migration. It will be understood by a person skilled in the art that a new memory block in memory 114 references to a set of memory locations where data from the page-cache 110 is written into, these blocks can be fresh memory location or existing memory location that are overwritten. Thus, ensuring that any newly created page-cache entry is not evicted on source server 102 and destination server 104.

On the source server 102 after the file descriptor 204 is initialized the entire root disk of Vm1 is read onto server 104's page-cache 114, thereby populating the page-cache on the source server 102 with the contents of the Vm1's root disk. On the destination server 104, a second file descriptor 206 is initialized in the page-cache memory 114 of destination server 104, thereafter data from the root disk which has populated page-cache memory 110 is read on the page-cache memory 112 of Vm2. A person skilled in the art will realize that any data in the source server 102 page cache 110 can be overwritten.

It will be readily understood that page cache 114, 110 may be part of system memories of source and destination servers and are disclosed herein for simplicity as stand alone cache 110 and 114.

For migration of Vm1 from source server 102 to destination server 104 a shutdown or migration command is issued by the controller 124. A person skilled in the art will realize the Controller 124 may be a hypervisor or kernel which can issue such a command. After issuing of the command for migration root disk data of Vm1, copied in the page-cache 110 is then transferred onto root disk of destination server, more specifically data is first migrated to page-cache 114, which is performed at faster transfer rates as rate of data storage to root disk using the destination server's page-cache. The writing of data can be performed based on a scheduled maintenance or other external command(s). A person skilled in the art will realize that after issuance of migration command during the initial read of the Vm1's root disk and till the time the Vm1 is shutdown or migrated, the data on memory 108 may have made changes to its root disk, for example changes due to writing of some log files, modify access times on some inodes (index of file systems of unix) for files that were read, remove temporary files, etc. However, this will not result in any inconsistency, as part of the Vm1's migration, it will write it's modified page cache blocks to the memory 108. This modification happens via a call to the host operating system, as Vm1 do not perform disk modification operations directly. Since, duplicate page caches are coherent between the Vm1 and the source server 102, the page cache entries that are modified and written by the VM get invalidated on the host. Alternatively, the pages may be written out. Further, it can be assumed that since the time period between the initial read and the shutdown is small, the size of discrepancy in the source server's page cache is likely to be much smaller than the entire root disk size of the Vm.

The migration of data in response to migration command may be performed over Transmission Control Protocol or TCP to the destination server. A TCP application running on the destination server copies the incoming data to the root disk of the VM by populating the existing page cache entries of the destination VM2's root disk, which were earlier written into memory of Vm2.

Populating the existing cache entries of the destination server ensures that the data does not require to be written to the destination disk synchronously and updating of the page-cache entries. Once the TCP transfer and copy operations are complete, VM2 on the destination server is started. At this time, data in the page cache may still be in the process of being asynchronously written to the disk, but the VM starts up as it's reference to the disk data is retrieved from the page cache of the host operating system. Thus, a faster starting of VM2 on destination server is achieved. The file descriptor that was opened on source and destination servers, can now be closed on both source and destination servers. The operations of performing memory reads on the source server, and complete memory writes on the destination server, significantly reduces the disk transfer time between the two systems, thereby tremendously reducing VM downtime during cold migration. A person skilled in the art can understand the operation of copy can be performed using any other standard or non-standardized protocol.

The above disclosed method provides a unique method to speed up VM data migration where contrary to conventionally methods where most of the delay in migration is spent in reading disk data on one source server, and writing it to the disk on the destination server. Using page-cache is an improved method to get the data pre-copied to memory, from where transfer to remote system, and update to storage on the storage is again optimized by loading page-cache on the destination system. Experimental data shows a huge performance gain by this method, where the time that an instance is unreachable is very short.

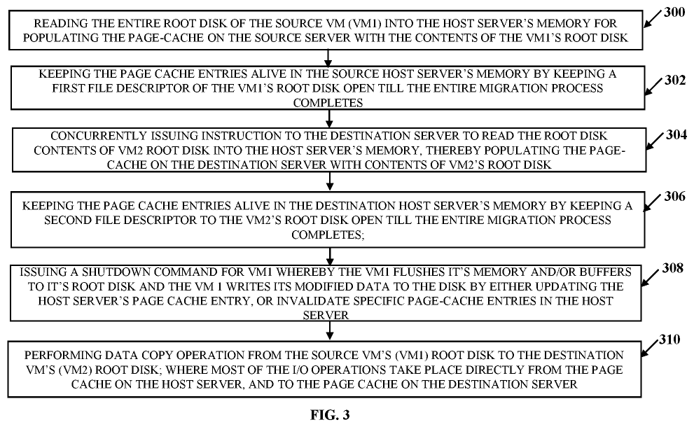

FIG. 3 illustrates a flow chart of the process of performing fast migration of data from a source Virtual Machine on a source host server to a destination host server where a destination virtual machine (VM2) will come live after migration is completes, wherein the migration is controlled based on instructions issued by a controller. Where step 300, entire root disk of the source VM (VM1) is copied into the host server's memory for populating the page-cache on the source server with the contents of the VM1's root disk. At step 302, for keeping the page cache entries alive in the source host server's memory a first file descriptor is initialized in the VM1's root disk which is kept open till the entire migration process completes. At step 304, instructions are issued to the destination server to read the root disk contents of VM2 root disk into the host server's memory, thereby populating the page-cache on the destination server with contents of VM2's root disk. At step 306, the page cache entries are kept alive in the destination host server's memory by keeping a second file descriptor to the VM2's root disk open till the entire migration process completes. At step 308, a shutdown command is issued for VM1 whereby the VM1 flushes it's memory and/or buffers to it's root disk and the VM 1 writes its modified data to the disk by either updating the host server's page cache entry, or invalidate specific page-cache entries in the host server. At step 310, performing data copy operation from the source VM's (VM1) root disk to the destination VM's (VM2) root disk; where most of the I/O operations take place directly from the page cache on the host server, and to the page cache on the destination server.

A person skilled in the are will realize that even for extremely high speed memory devices (e.g. SSD/NVME devices), the performance improvement may be lower. However, the present invention will always outperform any other method of disk transfer technology.

In another embodiment if the data to be transferred is too large, for example similar or larger than system memory, then the entire content of the disk will not be kept in the page cache. The cache 110 can load a certain amount of data depending on the cache size and then transfer the loaded data to cache 114 of the destination server for writing into destination server cache 114. Once, this copy operation is complete remaining data can be similarly transferred sequentially or on need basis. In this embodiment the pointer is retained during the entire coping operation.

In an experimental setup, a VM with a 10 GB local root HDD is migrated from destination server to another server over a 10g network interface card (NIC). The table below shows the time taken to transfer the contents of a 10G HDD to a different server using the Linux tool—netcat, and for the VM to boot up completely on the destination server to the login prompt. The time taken for the regular migration and the patented method are shown below in table 1.

TABLE 1

| | | Total time (disk transfer |
|---|---|---|
| | | including network transfer time, |
| | | VM shutdown on source, |
| | | VM startup on destination, and |
| Migration | | system ready upto the login |
| method | Disk transfer time | prompt on destination server) |
| Normal | 10737418240 bytes (11 | 7 minutes 32.1 seconds |
| optimazation | GB) copied, 417.328 s | |
| | 25.7 MB/s | |
| Optimized | 10737418240 bytes (11 | 54.8 seconds |
| method | GB) copied, 40.3653 s | |
| | 266 MB/s | |

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the structuring and implementation within the principles of the invention to the full extent indicated by the broad general meaning of the terms. Thus, various modifications are possible of the presently disclosed system and method without deviating from the intended scope and spirit of the present invention.

We claim:

1. A method for migration of a source Virtual Machine (VM1) on a source host server to a destination host server, wherein the migration is controlled based on instructions issued by a controller, comprising steps of:
reading, a root disk of the source VM (VM1) into a host server's memory;
sustaining page cache entries active in the source host server's memory by keeping a first file descriptor of the VM1's root disk open till the entire migration process is completed;
issuing instruction to the destination host server to read the root disk contents of a Virtual Machine 2 (VM2) root disk into a destination host server's memory;
sustaining the page cache entries alive in the destination host server's memory by keeping a second file descriptor to the VM2's root disk open until the entire migration process is completed;
issuing a shutdown command for the VM1, wherein the VM1 flushes memory and buffers to host root disk and the VM1 writes modified data to the disk by either updating the host server's page cache entry, or invalidate specific page cache entries in the host server; and
performing data copy operation from the VM1's root disk to the destination VM's (VM2) root disk, wherein the input-output operations occur directly from the page cache on the host server, and to the page cache on the destination host server.

2. The method as claimed in claim 1, comprising initializing one of a new file descriptor and reusing an existing file descriptor for reading data from source root disk so as to copy over the network to the destination host server, wherein disk contents of VM1's root disk are present in a source server's page cache due to earlier read operation.

3. The method as claimed in claim 1, comprising:
copying incoming data from the source host server to the root disk on the destination host server; and
utilizing one of a new file descriptor and reusing an existing file descriptor to the VM2's root disk, wherein the data being copied is written to the page cache rather than the disk due to the presence of a file-descriptor, which is already kept open to the VM2's root disk on the destination host server.

4. The method as claimed in claim 1, wherein once network transfer and the data copy operations are complete, the VM2 is started on the destination host server where open file descriptors are closed.

5. The method as claimed in claim 1, wherein the root disk of the VM2 is free of any content being populated, wherein the root disk of the VM2 is an empty disk where the contents of the root disk of the VM2 are present in the destination host server's page-cache.

6. A data migration system for speedy migration of data from a source host server hosting a Virtual Machine (VM1) to a destination host server, wherein a destination host server virtual machine (VM2) comes live after the migration is completed, wherein the migration is controlled based on instructions issued by one of a controller and an orchestrator, comprising steps of:
reading entire root disk of the VM1 into the memory of the source host server for populating page cache on the source host server with the contents of the root disk of VM1;
sustaining page cache entries alive in the memory of the source host server by keeping a first file descriptor of the root disk of the VM1 open until the entire migration process is completed;
concurrently issuing instruction to the destination host server to read the contents of the root disk of the VM2 into the host server's memory, wherein the page cache is populated on the destination host server with contents of the root disk of VM2;
sustaining the page cache entries alive in the memory of the destination host server by keeping a second file descriptor to the root disk of the VM2 open until the entire migration process is completed;
issuing a shutdown command to the VM1, which causes the VM1 to flush one of memory and buffers associated with VM1 to the root disk, and the VM 1 writes modified data to the disk by either updating the page cache entry of the source host server, or invalidate specific page cache entries in the source host server; and
performing data copy operation from the root disk of the VM1 to the root disk of the destination VM2, wherein most of the I/O operations take place directly from the page cache on the host server, and to the page cache on the destination host server.

7. The system as claimed in claim 6, comprising one of initializing a new file descriptor and reusing an existing file descriptor for reading data from the source root disk so as to copy over the network to the destination host server, wherein the disk contents of the root disk of the VM1 are present in the page cache of the source host server due to the earlier read operation.

8. The system as claimed in claim 6, comprising:
copying incoming data from the source host server to the root disk on the destination host server; and
utilizing one of a new file descriptor and reusing an existing file descriptor to the root disk of the VM2, so that the data being copied is instead written to the page cache rather than the root disk due to the presence of a file-descriptor which is already kept open to the root disk of the VM2 on the destination host server.

9. The system as claimed in claim 8, wherein once a network transfer and the copy operations are complete, the VM2 is started on the destination host server, wherein the open file descriptors are closed.

10. The system as claimed in claim 6, wherein the root disk of the VM2 is free of any content being populated, wherein the root disk of the VM2 is an empty disk where the contents of the root disk of the VM2 are present in the destination host server's page-cache.

11. A computer program product for migration of a source Virtual Machine (VM1) on a source host server to a destination host server, wherein the migration is controlled based on instructions issued by a processor, wherein the instructions when executed by the processor causes the processor to:
read a root disk of the source VM (VM1) into a host server's memory;
sustain page cache entries alive in the source host server's memory by keeping a first file descriptor of the VM1's root disk open till the entire migration process is completed;
issue instruction to the destination host server to read the root disk contents of a Virtual Machine 2 (VM2) root disk into a destination host server's memory;
sustain the page cache entries alive in the destination host server's memory by keeping a second file descriptor to the VM2's root disk open until the entire migration process is completed;
issue a shutdown command for the VM1, wherein the VM1 flushes memory and buffers to host root disk and the VM1 writes modified data to the disk by either updating the host server's page cache entry, or invalidate specific page cache entries in the host server; and
perform data copy operation from the VM1's root disk to the destination VM's (VM2) root disk, wherein the input-output operations occur directly from the page cache on the host server, and to the page cache on the destination host server.
